(19) United States
(12) Patent Application Publication
(10) Pub. No.: US 2007/0050421 A1
(43) Pub. Date: Mar. 1, 2007

(54) Document management system, method of setting document management system, and computer product

(75) Inventor: Akira Kohno, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Ricoh Company, Ltd.

(21) Appl. No.: 11/509,114

(22) Filed: Aug. 23, 2006

(30) Foreign Application Priority Data
Aug. 23, 2005 (JP) 2005-241737

(51) Int. Cl. G06F 17/30

(52) U.S. Cl. 707/200

(57) ABSTRACT

A data storing unit stores at least one of cabinet data and user data. A data retrieving unit retrieves either one of the cabinet data and the user data from the data storing unit. A group creating unit creates a first group. A group retrieving unit retrieves a second group from existing groups. A group setting unit sets the either one of the cabinet data and the user data retrieved by the data retrieving unit in either one of the first group and the second group. A user interface is provided for interfacing an operator with the document management system.

### PRIORITY

The present application claims priority to and incorporates by reference the entire contents of Japanese priority document, 2005-241737, filed in Japan on Aug. 23, 2005.

### BACKGROUND OF THE INVENTION

1. Field of the Invention

The present invention relates to a technology for performing an initial setting using a group setting in a document management system.

2. Description of the Related Art

In a document management system that can be connected via a network, an initial setting is necessary, such as giving permission for a user to connect to the document management system, selecting a cabinet to be used by the user, or providing user authorization for using the document management system. The document management system connected to the network includes, in the same network, a document management apparatus containing a high-capacity document storage device, and includes a plurality of personal computers (PC). The document management apparatus registers and stores therein a plurality of pieces of document data acquired from the PCs. When one of the PCs sends a request of retrieving the document data from the document management apparatus, the requested document data can be downloaded from the document management apparatus to the PC for a use.

Generally, upon registering the document data, the document data stored in the document storage device is sorted into groups that are managed using a directory (folder) structure containing directories (folders) corresponding to the groups so that the user can easily access to the document data. Namely, the user firstly creates the folders for storing the document data, determines how to sort the document data based on the contents of the document data, transfers or copies the document data to the determined folders based on the sort, and registers the document data therein. A user who connects to the document management system for the first time needs to select a cabinet to be accessed for a use.

Japanese Patent Application Laid-Open No. 2001-51983 discloses a technology for managing document data that can easily register a large amount of document data. Specifically, a user can specify an original folder that contains document data to be registered into a document management apparatus, and can also specify a destination folder to which the document data is to be registered. Thereafter, the user causes the document data to be registered, and whole document data in the original folder are registered to the destination folder based on the instruction.

In the above document management system, a plurality of document data containing various contents is stored in a database. Accordingly, it is usual that some document data in the database is not allowed to be used by all users connecting to the document management system due to a variation of the contents or nature of the document, while other document data in the same database is allowed to be used by all the users. Generally, a security management for the document data is realized by restricting access right to the document data using a group setting for the management, or giving an access right and a password to the document data. The security management is usually performed by a person responsible for the administration. For example, Japanese patent Application Laid-Open No. 2002-288043 discloses a technology for effectively managing document data and a group of document data without managing user accounts. Specifically, a password for managing and another password for accessing are given to each piece of document data. Further, a system password for managing the entire document management system is given to the document management system.

A user who connects to the document management system for the first time needs to select and register a cabinet to be accessed for a use from among the cabinets in the document management system. However, because there are one or more cabinets in the document management system, it is troublesome for a user to perform a series of operations one by one for selecting and registering each cabinet.

As described above, the person responsible for the administration provides user authorization for each user connecting to the document management system. FIG. 9 is a flowchart of a conventional processing procedure for an operation of setting user authorization. The document management system is started (step S901), and a user list is displayed (step S902). A user is selected from the user list for setting the user authorization (step S903). Thereafter, contents of each user authorization are determined (step S904). When it is determined to set the user authorization to the user (YES at step S905), the user authorization is set to the user (step 906). When it is determined not to set the user authorization to the user (NO at step S905), process control returns to step S903. FIG. 10 is an example of a conventional user interface for setting the user authorization for the users as shown in FIG. 9. With the conventional processing procedure, it is cumbersome for a person to set user authorization one by one for a user capable of connecting to the document management system.

### SUMMARY OF THE INVENTION

A document management system, a method of setting document management system, and a computer product are described. In one embodiment, a document management system to which a server and a client terminal are connected via a network, where the client terminal has at least an initial setting set by a user, the document management system comprising a data storing unit that stores at least one of cabinet data and user data, a data retrieving unit that retrieves either one of the cabinet data and the user data from the data storing unit, a group creating unit that creates a first group, a group retrieving unit that retrieves a second group from existing groups, a group setting unit that sets the either one of the cabinet data and the user data retrieved by the data retrieving unit in either one of the first group and the second group, and a user interface for interfacing an operator with the document management system.

### BRIEF DESCRIPTION OF THE DRAWINGS

FIG. 1 is a block diagram of a server used in a document management system according to an embodiment of the present invention;

FIG. 2 is a block diagram for illustrating a module configuration in the document management system;

FIG. 3 is a flowchart of a processing procedure for an operation of setting a group of cabinets according to the embodiment;

FIG. 4 is a flowchart of a processing procedure for an operation of setting a group of cabinet groups according to the embodiment;

FIG. 5A is an example of a user interface for setting the group of the cabinets shown in FIG. 3;

FIG. 5B is an example of a user interface for setting the group of the cabinet groups shown in FIG. 4;

FIG. 6 is a flowchart of a processing procedure for an operation of setting a group of users according to the embodiment;

FIG. 7 is a flowchart of a processing procedure for an operation of setting a group of user groups according to the embodiment;

FIG. 8A is an example of a user interface for setting the group of the users shown in FIG. 6;

FIG. 8B is an example of a user interface for setting the group of the user groups shown in FIG. 7;

FIG. 9 is a flowchart of a conventional processing procedure for an operation of setting user authorization for users; and

FIG. 10 is an example of a conventional user interface for setting the user authorization for the users.

### DETAILED DESCRIPTION OF THE PREFERRED EMBODIMENTS

Embodiments of the present invention at least partially solve problems described above in the conventional technology.

A document management system according to one embodiment of the present invention is connected to a server and a client terminal via a network, where the client terminal has at least an initial setting set by a user. The document management system includes a data storing unit that stores at least one of cabinet data and user data; a data retrieving unit that retrieves either one of the cabinet data and the user data from the data storing unit; a group creating unit that creates a first group; a group retrieving unit that retrieves a second group from existing groups; a group setting unit that sets the either one of the cabinet data and the user data retrieved by the data retrieving unit in either one of the first group and the second group; and a user interface for interfacing an operator with the document management system.

A method according to another embodiment of the present invention is for setting a document management system to which a server and a client terminal are connected via a network, where the client terminal has at least an initial setting set by a user. The method includes storing at least one of cabinet data or user data in the server; retrieving either one of the stored cabinet data and the stored user data stored; creating a first group; retrieving a second group from existing groups; setting the either one of the retrieved cabinet data and the retrieved user data in either one of the first group and the second group. An operator performs each of the operations using a user interface.

A computer-readable recording medium according to still another embodiment of the present invention stores therein a computer program for setting a document management system to which a server and a client terminal are connected via a network, where the client terminal has at least an initial setting set by a user. The computer program causes a computer to perform the following: storing at least one of cabinet data or user data in the server; retrieving either one of the stored cabinet data and the stored user data; creating a first group; retrieving a second group from existing groups; setting the either one of the retrieved cabinet data and the retrieved user data in either one of the first group and the second group, where an operator performs each of the operations using a user interface.

The above and other embodiments, features, advantages and technical and industrial significance of this invention will be better understood by reading the following detailed description of presently preferred embodiments of the invention, when considered in connection with the accompanying drawings.

Exemplary embodiments of the present invention are explained below in detail with reference to the accompanying drawings. The present invention is not limited to the embodiments explained below.

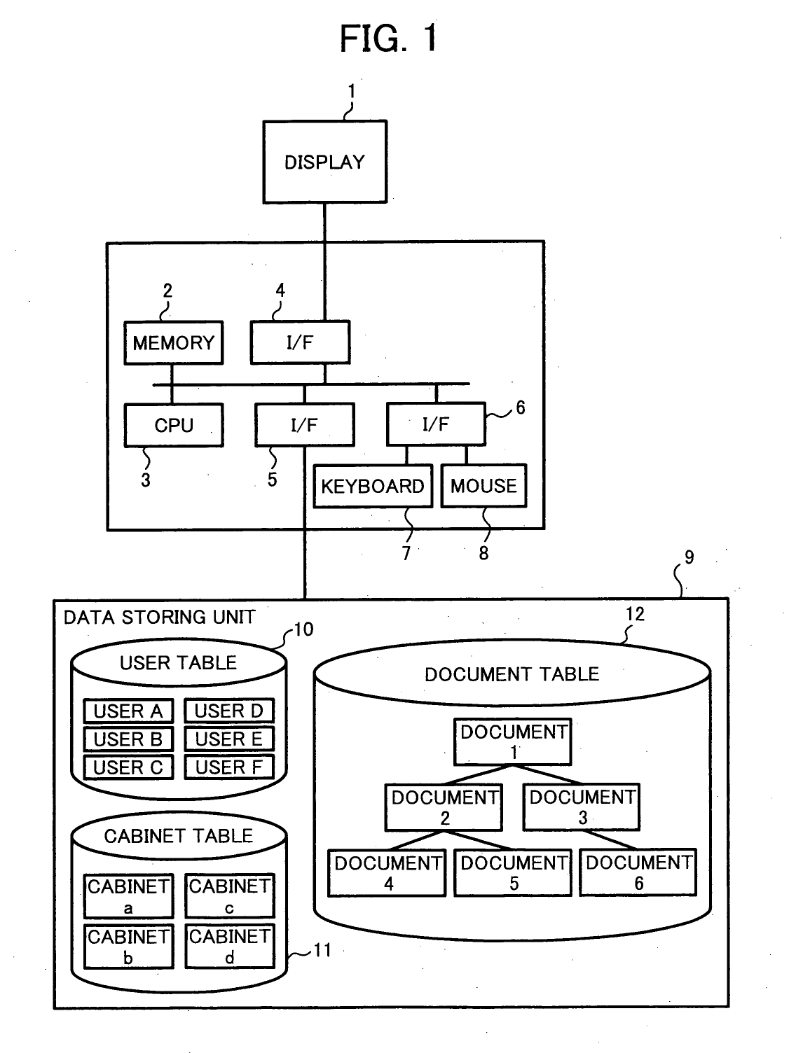

FIG. 1 is a block diagram of a server used in a document management system according to an embodiment of the present invention. The server includes a display 1, a memory 2, a central processing unit (CPU) 3, interfaces (I/F) 4 to 6, a keyboard 7, a mouse 8, a data storing unit 9, a user table 10, a cabinet table 1, and a document table 12. The CPU 3 controls the entire document management system. The memory 2 is mainly used as a work area for the CPU 3. The display 1 is, for example, a liquid crystal display and displays data and the like thereon via the I/F 4. The keyboard 7 and the mouse 8 assist a user to input data to be input via the I/F 6. The data storing unit 9 is, for example, a hard disk drive structured with a magnetic disk, and stores therein data-tables such as the user table 10, the cabinet table 11, the document table 12, and other software. The data storing unit 9 is connected to the I/F 5 in order to transmit data to each unit such as a memory unit based on the control of the CPU 3. The user table 10 stores data related to users and is used for setting user authorization for the users. The cabinet table 11 stores therein data related to cabinets and is used for selecting one of the cabinets. The document table 12 stores therein document data after a registration.

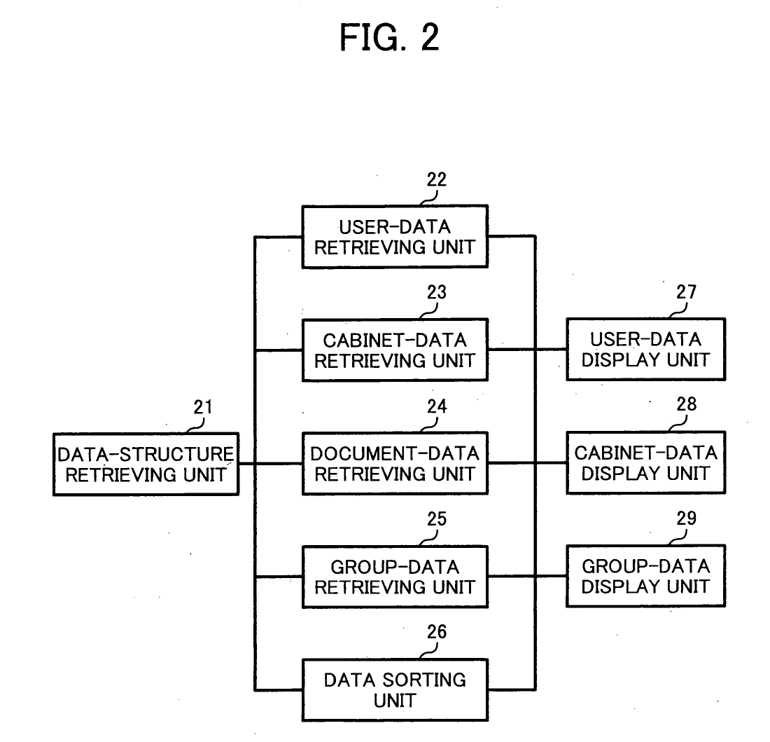

FIG. 2 is a block diagram for illustrating a module configuration in the document management system. The module configuration includes a data-structure retrieving unit 21, a user-data retrieving unit 22, a cabinet-data retrieving unit 23, a document-data retrieving unit 24, a group-data retrieving unit 25, a data sorting unit 26, a user-data display unit 27, a cabinet-data display unit 28, and a group-data display unit 29.

The data-structure retrieving unit 21 retrieves any one of the modules among user data, cabinet data, document data, and group data. The user-data retrieving unit 22 retrieves existing user data, for example, user account or user authorization data, stored in the data storing unit 9. The cabinet-data retrieving unit 23 retrieves existing cabinet data stored in the data storing unit 9. The document-data retrieving unit 24 retrieves document data stored in the data storing unit 9. The group-data retrieving unit 25 retrieves group data stored in the data storing unit 9. The user-data retrieving unit 22, the cabinet-data retrieving unit 23, and the document-data retrieving unit 24 correspond to a data retrieving unit according to the present invention. On the other hand, the group-data retrieving unit 25 corresponds to a group retrieving unit according to the present invention.

The data sorting unit 26 sorts the retrieved data into groups and registers the document data to a specific cabinet. As for the function of sorting the data into the groups, the data sorting unit 26 corresponds to a group setting unit according to one embodiment of the present invention. The user-data display unit 27 is used for modifying existing user data, such as determining new user authorization for users, and creating new user data. The cabinet-data display unit 28 is used for modifying existing group data and creating new cabinet data. The group-data display unit 29 is used for modifying existing group data and creating new group data. The group-data display unit corresponds to a group creating unit according to one embodiment of the present invention.

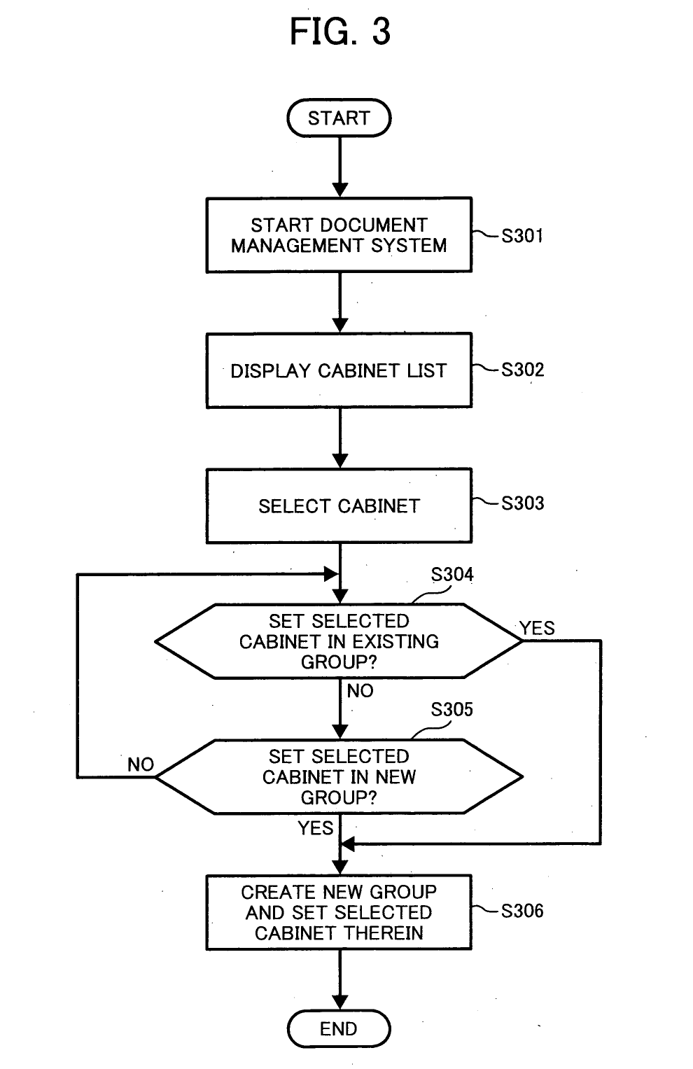

FIG. 3 is a flowchart of a processing procedure for an operation of setting a group of cabinets according to the embodiment. The group of the cabinets is set before a user performs processing for selecting a cabinet to be accessed. The document management system is started (step S301), and a cabinet list is displayed (step S302). At least one cabinet to be set in a group is selected from the cabinet list (step S303). When the selected cabinet is to be set in an existing group for registering (YES at step S304), the selected cabinet is set in the existing group (step S306). When the selected cabinet is to be set in a new group (NO at step S304, YES at step S305), the new group is created and the selected cabinet is set therein (step S306).

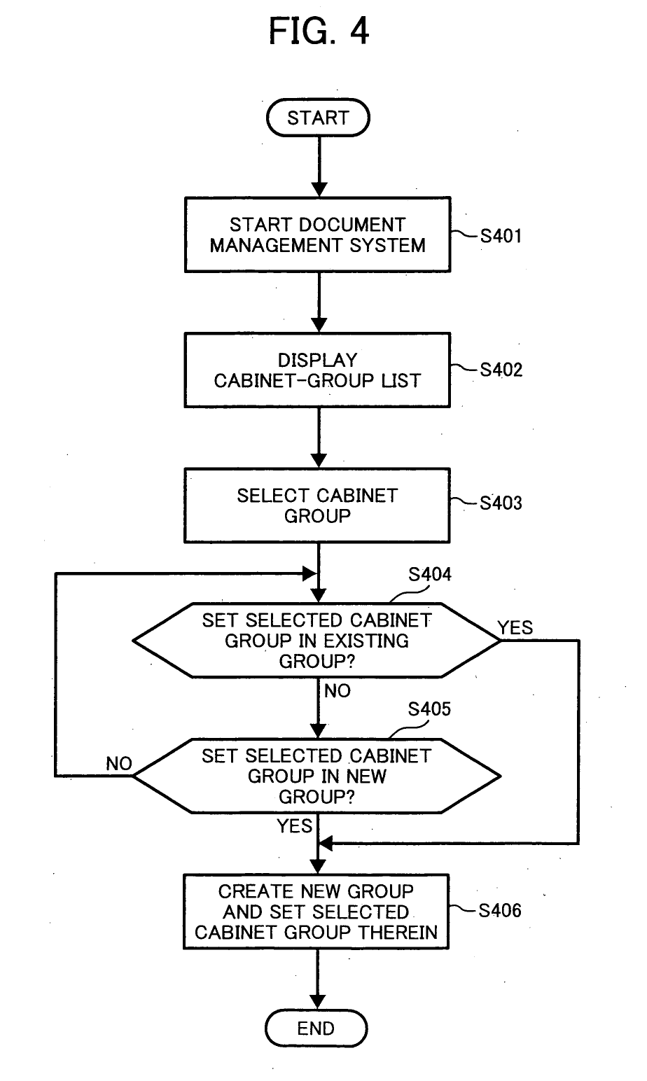

FIG. 4 is a flowchart of a processing procedure for an operation to set a group of cabinet groups according to the embodiment. Compared with the processing procedure shown in FIG. 3, in which the group is set with the selection of at least one cabinet from among the cabinets, a group is to be set with the selection of at least one cabinet group from among the cabinet groups that have been set as shown in FIG. 3. General flow of the processing procedure shown in FIG. 4 is the same as that shown in FIG. 3; however, the cabinet groups, not the cabinets, are to be selected into a group.

The document management system is started (step S401), and a cabinet-group list is displayed (step S402). At least one cabinet group to be set in a group is selected from the cabinet-group list (step S403). When the selected cabinet group is to be set in an existing group (YES at step S404), the selected cabinet group is set in the existing group (step S406). When the selected cabinet group is to be set in a new group (NO at step S404, YES at step S405), the new group is created and the selected cabinet group is set therein (step S406).

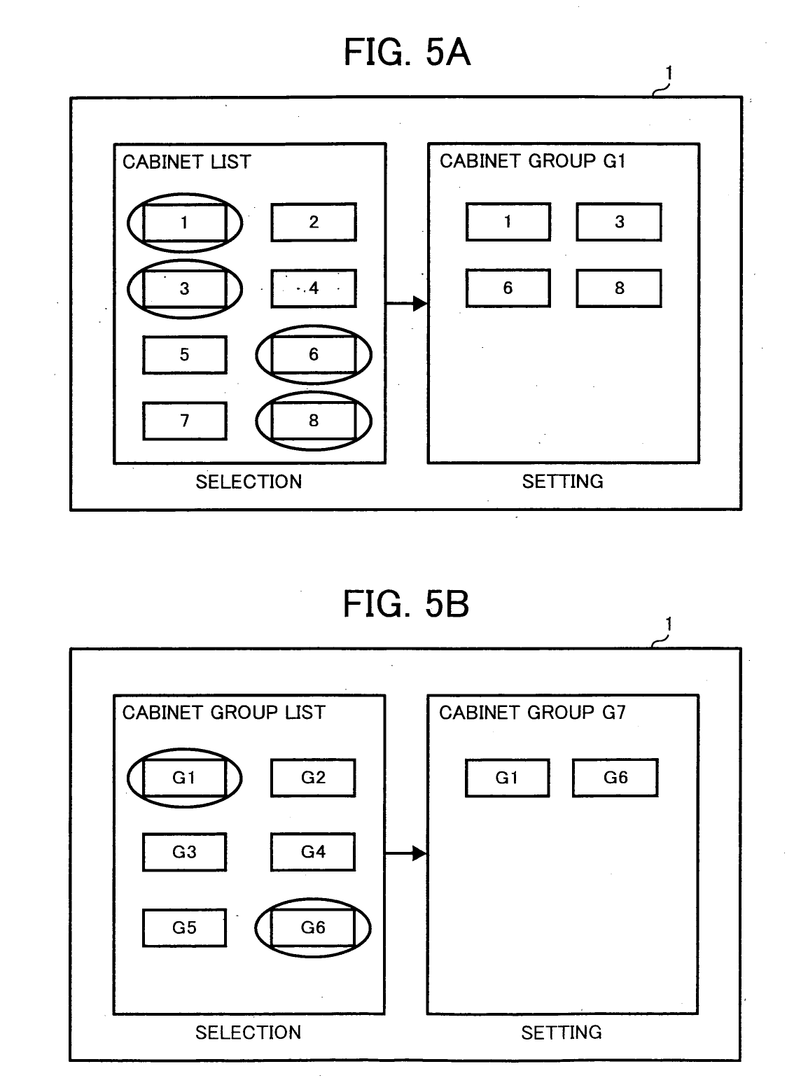

FIG. 5A is an example of a user interface for setting the group of the cabinets shown in FIG. 3. FIG. 5B is an example of a user interface for setting the group of the cabinet groups shown in FIG. 4. It is preferable to apply, for example, a graphical user interface (GUI) method to the user interfaces because the GUI method makes processing procedure easy for a user to perform. The groups of the cabinets and the group of the cabinet groups are set and, thereafter, are displayed so that a user can perform processing for selecting a cabinet or a cabinet group. The user can perform the processing for selecting a cabinet or a cabinet group using the set groups shown in FIGS. 5A and 5B.

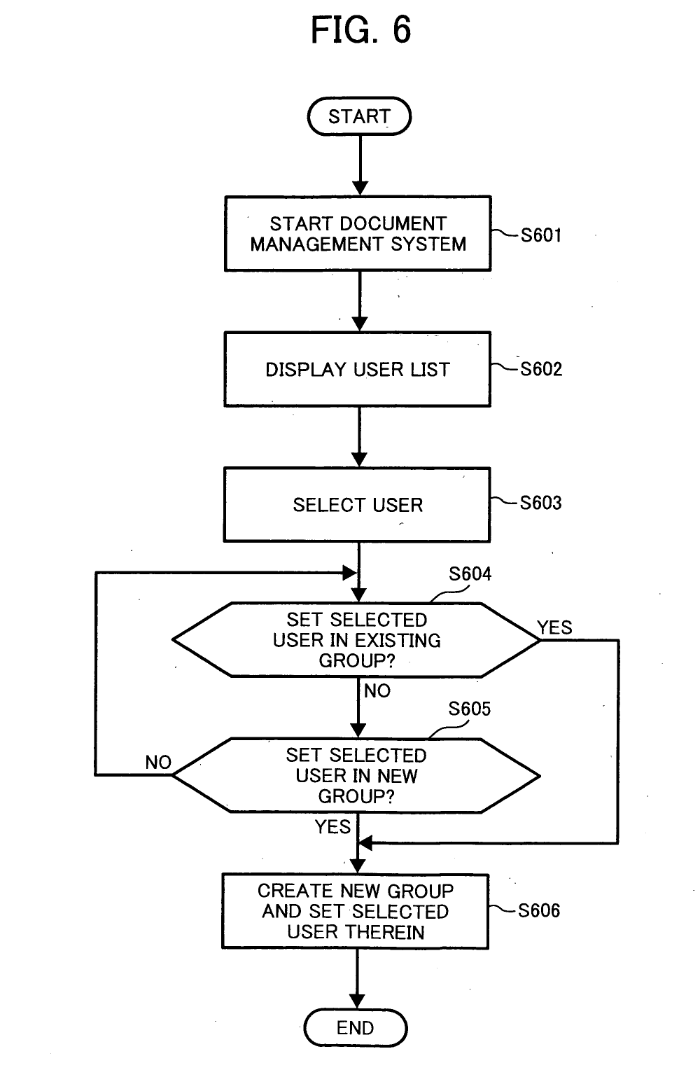

FIG. 6 is a flowchart of a processing procedure for an operation of setting a group of users according to the embodiment. The group of the user is to be set before setting user authorization for users. The document management system is started (step S601), and a user list is displayed (step S602). A user to be set in a group is selected from the user list (step S603). When the selected user is to be set in an existing group (YES at step S604), the selected user is set in the existing group (step S606). When the selected user is to be set in a new group (NO at step S604, YES at step S605), the new group is created and the selected user is set therein (step s606).

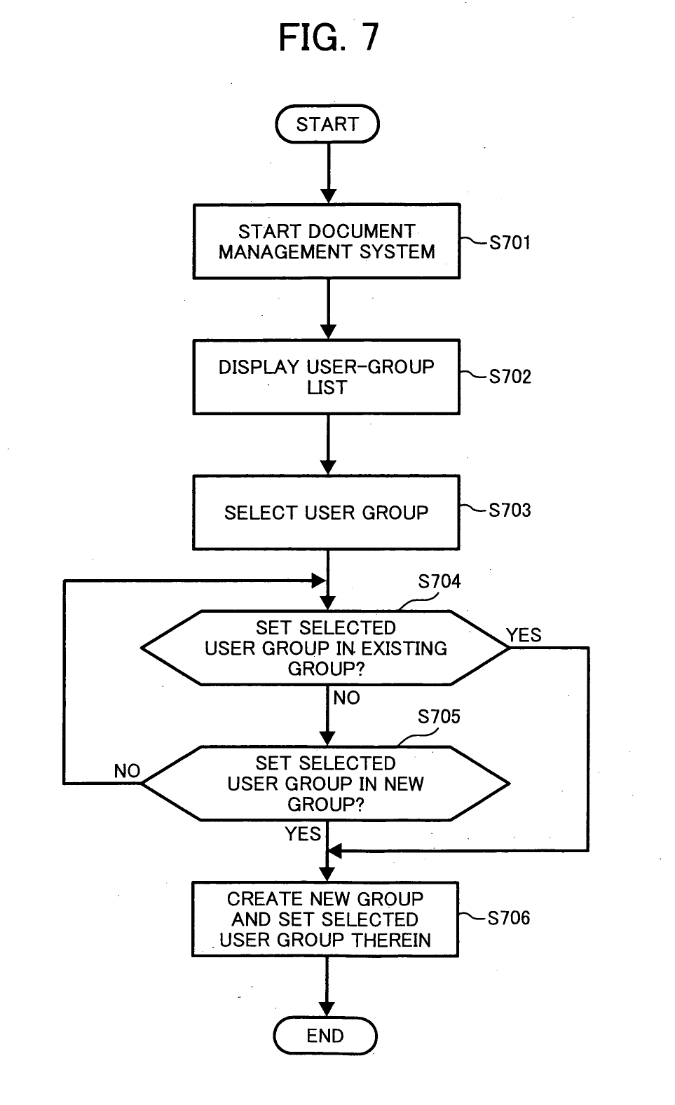

FIG. 7 is a flowchart of a processing procedure for an operation of setting a group of user groups according to the embodiment. Compared to the processing procedure shown in FIG. 6, in which the group is set with the selection of at least one user from among the users, a group is set with the selection of at least one user group from among the user groups that have been set as shown in FIG. 6. General flow of the processing procedure shown in FIG. 7 is the same as that shown in FIG. 6; however, the user groups, not the users, are selected into a group.

The document management system is started (step S701), and a user-group list is displayed (step S702). A user group to be set in a group is selected from the user-group list (step S703). When the selected user group is to be set in an existing group (YES at step S704), the selected user group is set in the existing group (step S706). When the selected user group is to be set in a new group (NO at step S704, YES at step S705), the new group is created and the selected user group is set therein (step s706).

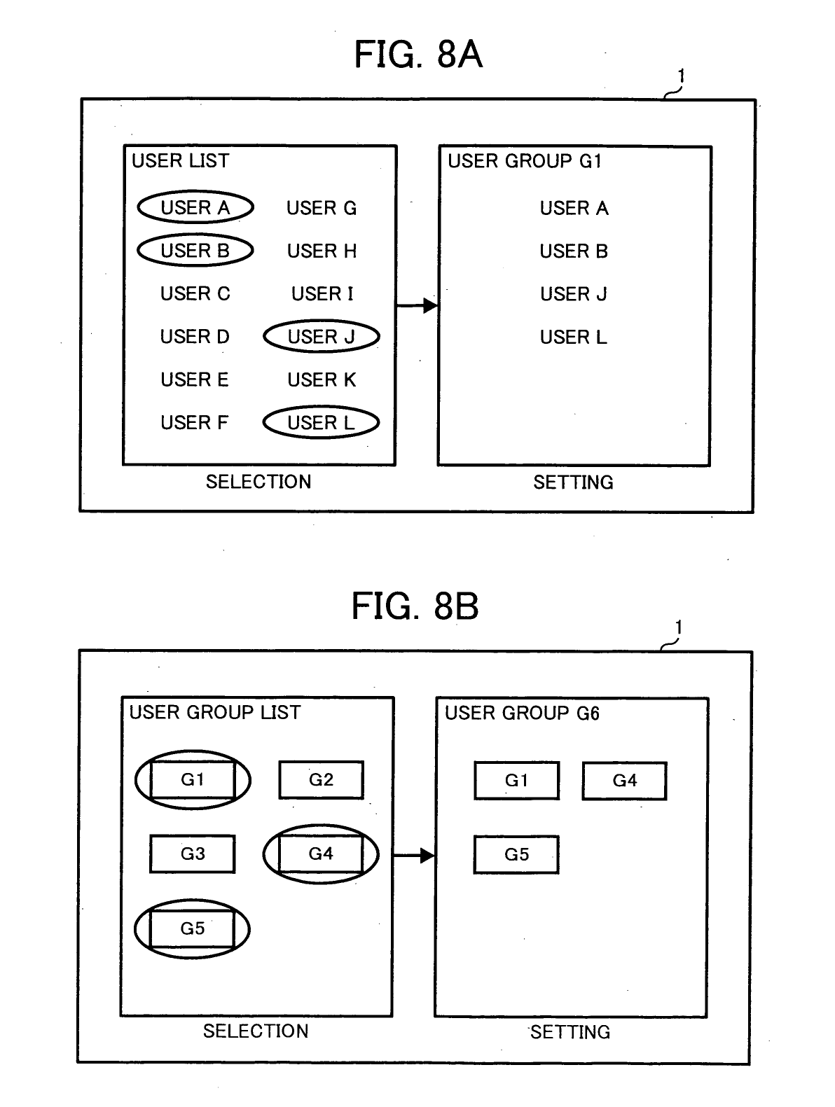

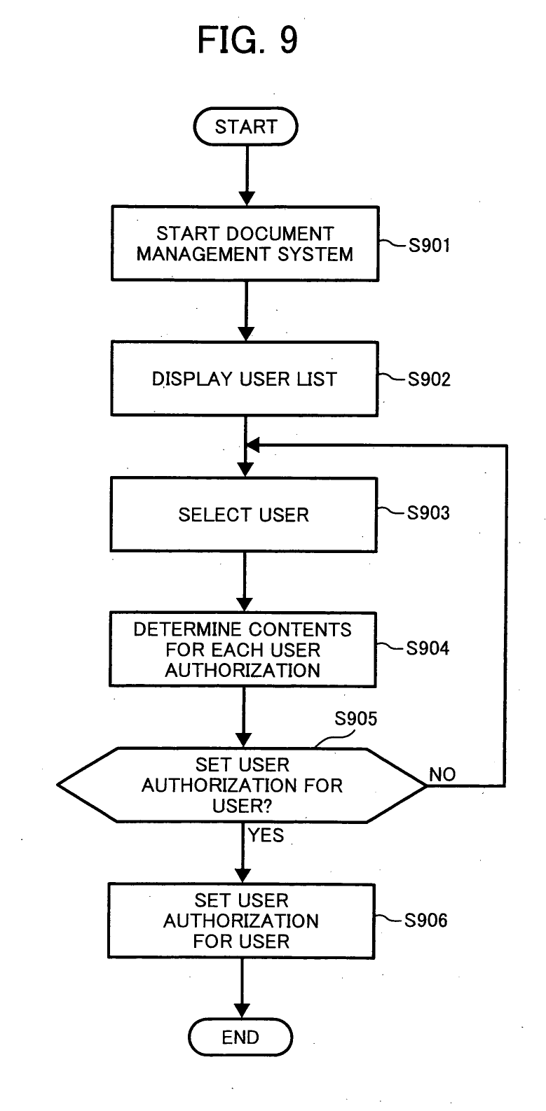

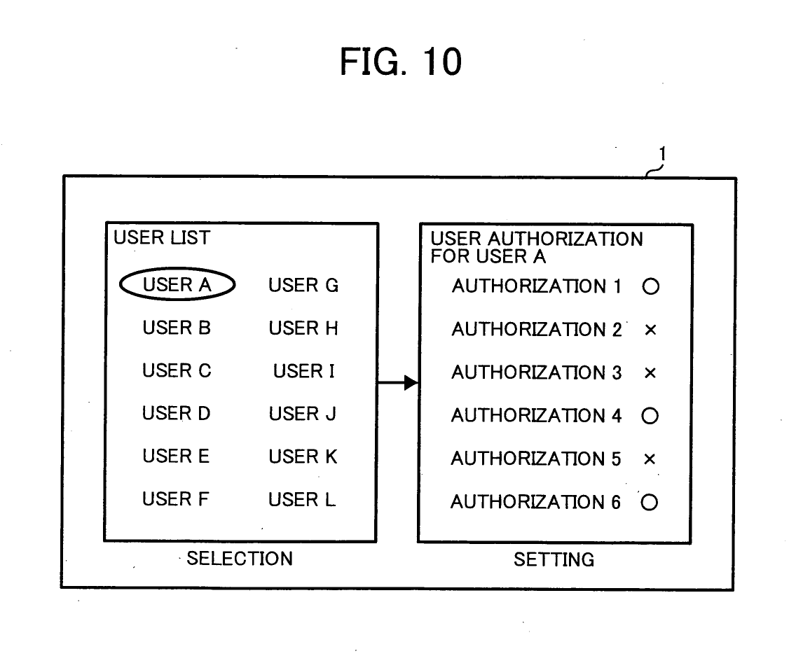

FIG. 8A is an example of a user interface for setting the group of the users shown in FIG. 6. FIG. 8B is an example of a user interface for setting the group of the user groups shown in FIG. 7. It is preferable to apply the GUI method to the user interfaces as explained in FIGS. 5A and 5B.

It is possible to perform processing for setting user authorization using the set user groups, with at least six patterns explained below:

(1) a user X, a user Y, a user Z are set in a new user group G0(G zero), and user authorization is provided to the user group G0(G zero);

(2) the user X is set in an existing user group G1, and user authorization set to the user group G1 is applied to the user X;

(3) the user X is set in the user group G1, and user authorization is set to the user group G6;

(4) a user group G10 and a user group G20 are set in a new user group G100, and user authorization is set to the user group G100;

(5) the user group G10 is set in the user group G1, and user authorization set to the user group G1 is applied to the user group G10; and

(6) the user group G10 is set in the user group G1, and user authorization is set to the user group G1.

As described above, by setting user authorization for the user groups before setting user authorization for each user, it becomes possible to effectively perform processing for setting user authorization depending on various situations.

According to the embodiment, the cabinets in the cabinet list are sorted into the groups based on user's need. Thereby, the user can easily perform the operation for setting a cabinet to be accessed.

Furthermore, according to the embodiment, because the user groups are set in advance, it becomes possible to easily provide user authorization or perform other initial settings.

Although the embodiment is explained in relation to the document management system, a method of setting groups used in the document management system, a computer program that causes a computer to execute the method of setting groups, and a computer-readable recording medium that stores therein the computer program are included in the embodiment according to the present invention. Namely, only a preferable embodiment is explained above and the present invention is not limited to the specific details and representative embodiments shown and described herein. Accordingly, various modifications can be made without departing from the spirit or scope of the general inventive concept of the present invention.

According to an embodiment of the present invention, in a document management system that can be connected via a network, it becomes possible to effectively perform an operation of an initial setting for establishing a system connection and the operation can become easily performed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A document management system for connection to a server and a client terminal via a network, the client terminal having at least an initial setting that is set by a user, the document management system comprising:
a data storing unit to store at least one of cabinet data and user data;
a data retrieving unit to retrieve either one of the cabinet data and the user data from the data storing unit;
a group creating unit to create a first group;
a group retrieving unit to retrieve a second group from existing groups;
a group setting unit to set the either one of the cabinet data and the user data retrieved by the data retrieving unit in either one of the first group and the second group; and
a user interface to interface an operator with the document management system.

2. The document management system according to claim 1, wherein
the data retrieving unit retrieves the cabinet data,
the first group is a new cabinet group,
the second group is an existing cabinet group, and
the group setting unit sets the cabinet data retrieved by the data retrieving unit in either one of the new cabinet group and the existing cabinet group.

3. The document management system according to claim 2, wherein
the data retrieving unit retrieves the cabinet data that is set in a group by the group setting unit.

4. The document management system according to claim 1, wherein
the data retrieving unit retrieves the user data,
the first group is a new user group,
the second group is an existing user group, and
the group setting unit sets the user data retrieved by the data retrieving unit in either one of the new user group and the existing user group.

5. The document management system according to claim 4, wherein
the data retrieving unit retrieves the user data that is set in a group by the group setting unit.

6. A method of setting a document management system to which a server and a client terminal are connected via a network, the client terminal having at least an initial setting set by a user, the method comprising:
storing at least one of cabinet data or user data in the server;
retrieving either one of the stored cabinet data and the stored user data;
creating a first group;
retrieving a second group from existing groups;
setting either one of the retrieved cabinet data and the retrieved user data in either one of the first group and the second group, wherein
an operator performs each of the operations using a user interface.

7. The method according to claim 6, wherein
retrieving either the stored cabinet data and the stored user data includes retrieving the cabinet data,
the first group is a new cabinet group,
the second group is an existing cabinet group, and
setting either the retrieved cabinet data or the retrieved user data includes setting the retrieved cabinet data in either one of the new cabinet group and the existing cabinet group.

8. The method according to claim 7, wherein
retrieving either the stored cabinet data and the stored user data includes retrieving the cabinet data that is set in a group when setting either the retrieved cabinet data or the retrieved user data includes setting the retrieved cabinet data.

9. The method according to claim 6, wherein
retrieving either the stored cabinet data and the stored user data includes retrieving the user data,
the first group is a new user group,
the second group is an existing user group, and
setting either the retrieved cabinet data or the retrieved user data includes setting the retrieved user data in either one of the new user group and the existing user group.

10. The method according to claim 9, wherein
retrieving either the stored cabinet data and the stored user data includes retrieving the user data that is set in a group at the group when setting either the retrieved cabinet data or the retrieved user data.

11. A computer-readable recording medium that stores therein a computer program for setting a document management system to which a server and a client terminal of which at least an initial setting is performed by a user are connected via a network, wherein
the computer program causes a computer to execute:
storing at least one of cabinet data or user data in the server;
retrieving either one of the stored cabinet data and the stored user data stored;
creating a first group;
retrieving a second group from existing groups;
setting the either one of the retrieved cabinet data and the retrieved user data in either one of the first group and the second group, and
an operator performs each of the operations using a user interface.
